(19) United States
(12) Patent Application Publication
(10) Pub. No.: US 2012/0234564 A1
(43) Pub. Date: Sep. 20, 2012

(54) Apparatus and Related Methods for Deactivating Fire Sprinkler Heads

(76) Inventor: Matthew Scarpuzzi, San Diego, CA (US)

(21) Appl. No.: 13/371,233

(22) Filed: Feb. 10, 2012

Related U.S. Application Data
(60) Provisional application No. 61/465,257, filed on Mar. 17, 2011.

(51) Int. Cl. A62C 37/00

(52) U.S. Cl. 169/90

(57) ABSTRACT

Disclosed are an apparatus and related methods for quickly deactivating or otherwise plugging a sprinkler, wherein the deactivated sprinkler may automatically reactivate in view of an unexpected fire. Generally, the disclosed apparatus comprises: a piston pump that is in fluid communication with an inflatable bladder. In one mode of operation, the bladder of said apparatus may be disposed within a nozzle of a sprinkler, the piston pump operated to inflate the bladder, and wherein said inflated bladder blocks fluid from escaping the nozzle. Suitably, the working components of the apparatus may be configured to melt whenever ambient temperatures surrounding the sprinkler reach a threshold level so that the sprinkler may reactivate in view of an unexpected fire in its proximity.

### CROSS-REFERENCE TO RELATED APPLICATIONS

This application claims the priority and benefit of U.S. Prov. Pat. App. Ser. No. 61/465,257 (filed Mar. 17, 2011) entitled “Scar tool.”

### STATEMENT REGARDING FEDERALLY SPONSORED RESEARCH OR DEVELOPMENT

Not applicable.

### BACKGROUND OF THE INVENTION

1. Field of Invention

This invention relates to apparatus and related methods for blocking the flow of water from a broken or activated fire sprinkler.

2. Background

Fire sprinkler systems are frequently placed in buildings as a mechanism for fighting unexpected or out of control fires. Structurally, the individual sprinklers within the system generally feature a plugged nozzle that is (a) located at the end of a fluid filled or fluid fed pipe and (b) directed toward a deflector plate, wherein the plug is configured to give way to the fluid whenever heated beyond a threshold temperature so that water flows from the nozzle into the deflector plate. See, e.g., U.S. Pat. No. 4,616,710 (issued Oct. 14, 1986); see also vials filled with heat-expanding fluids which rupture when heated to a threshold temperature. While unplugged, a condition that is known colloquially as “activated,” the fluid flows from the sprinkler and is deflected over an area within the building until the pipe is either drained of fluid, the fluid feed is shut-off, or the nozzle is re-plugged.

For fluid filled sprinkler systems, occasions arise wherein plugging the activated nozzle is more preferable than draining the pipe or shutting-off the fluid feed. Plugging an accidentally activated nozzle is preferred to draining the pipe because, otherwise, the fluid is unnecessarily wasted or causes damage. Plugging an activated nozzle is also preferred to draining the pipe whenever either: (1) all the fluid is not necessary to extinguish a fire because water is otherwise wasted; or (b) historic pipe conditions (e.g., rust, bacteria, mold and the like) or chemical additives have rendered toxic the fluid since the toxic fluid can cause damage to humans and environments proximate to the sprinkler system.

For fluid fed sprinkler systems, circumstances arise wherein plugging activated nozzles is more preferable than shutting-off the fluid feed of the system. Like fluid filled systems, fluid fed sprinkler systems should be plugged whenever its sprinklers are either activated accidentally or contain toxic fluid to avoid wasted fluid or fluid damage. Plugging an activated sprinkler in a fluid fed system is usually preferred to shutting-off the fluid feed to the pipe whenever shutting-off the fluid feed either: is an expensive or difficult undertaking; results in no mechanisms for fire fighting while the feed is shut-off (i.e., the building is at risk because there is no fire prevention mechanism); or expensive or difficult to turn back on.

In view of the foregoing, a need exists for mechanism which are capable of deactivating or otherwise plugging a sprinkler. Apparatus and related methods have been developed to meet said need. Yet, until now none of said apparatus and methods have completely met said need.

Wedge apparatus are known which are configured to plug a sprinkler nozzle whenever positioned between the deflector plate and nozzle. See, e.g., U.S. Pat. No. 845,918 (issued Mar. 5, 1907), U.S. Pat. No. 2,700,423 (issued Jan. 25, 1955), and, U.S. Pub. Pat. App. No. 2008/0083544 (published Apr. 10, 2008). Although useful for quickly deactivating sprinklers, wedge apparatus are not entirely satisfactory for all circumstances. One unsatisfactory aspect of a wedge apparatus is that the interface between the wedge and the nozzle is not always water tight because of the wedge incline. Another unsatisfactory aspect of a wedge apparatus is that the wedge must be manually removed with the result being that the sprinkler cannot automatically activate in view of an unexpected fire.

Lift apparatus (whether by spring or screw operations) are also known for deactivating sprinklers, wherein a lower portion of the device is positioned against the deflector plate and an upper portion of the device is raised into plugging interface with the nozzle. See, e.g., U.S. Pat. No. 2,417,265 (issued Mar. 11, 1947), U.S. Pat. No. 2,520,588 (issued Aug. 29, 1950) U.S. Pat. No. 3,191,685 (issued Jun. 29, 1965), U.S. Pat. No. 3,223,171 (issued Dec. 14, 1965) U.S. Pat. No. 3,550,687 (issued Dec. 29, 1970), U.S. Pat. No. 3,976,141 (issued Aug. 24, 1976), U.S. Pat. No. 4,638,866 (issued Jan. 27, 1987), U.S. Pat. No. 5,560,430 (issued Oct. 1, 1996), U.S. Pat. No. 6,575,252 (issued Jun. 10, 2003), U.S. Pat. No. 7,743,838 (issued Jun. 29, 2010), and U.S. Pub. Pat. No. 2006/0042803 (published Mar. 2, 2006). Lift apparatus are sometimes unsatisfactory for deactivating sprinklers because such apparatus require careful, tedious, or difficult positioning and manipulation of the lift to plug the nozzle in a fluid tight manner. Additionally, lift apparatus, like wedge apparatus, must be manually removed from a sprinkler with a consequence that the sprinkler cannot automatically activate in view of an unexpected fire.

Capping apparatus are further known for deactivating sprinkler nozzles. See e.g., U.S. Pat. No. 2,985,242 (issued May 23, 1961), U.S. Pat. No. 4,676,320 (issued Jan. 30, 1987), U.S. Pat. No. 4,830,117 (issued May 16, 1989), U.S. Pat. No. 6,487,942 (issued Dec. 3, 2002). While capping apparatus are capable of plugging a sprinkler nozzle, capping apparatus cannot ordinarily be universally applied to all sprinklers. Also, like the wedge and lift apparatus, capping apparatus must be manually removed and, as a result, the sprinkler cannot automatically activate in view of an unexpected fire.

Balloon apparatus are known which are configured to expand between the deflector plate and nozzle opening whereby the expansion plugs the nozzle. See, e.g., U.S. Pat. No. 7,025,285 (issued Apr. 11, 2006). Balloon apparatus can be useful for quickly deactivating a sprinkler. However, balloon apparatus require a substantial amount of compressed air to accomplish deactivation of a sprinkler nozzle. Furthermore, compressed air sources are not always available. Accordingly, balloon apparatus are not satisfactory for deactivating sprinklers in all circumstances.

Finally, wedge, lift, capping, and balloon apparatus are not capable of plugging sheared or otherwise severely damaged sprinklers.

In view of the foregoing, a need still exists for apparatus and related methods of deactivating a sprinkler without the drawbacks or shortcomings of known apparatus for the same purpose.

### SUMMARY OF THE INVENTION

Disclosed are an apparatus and related methods for quickly deactivating or otherwise plugging a sprinkler, wherein the deactivated sprinkler may automatically reactivate in view of an unexpected fire. Generally, the disclosed apparatus comprises: a piston pump defined by a plunger that is movable within a fluid filled chamber; an expansible tip that is in fluid communication with said chamber; wherein said tip is configured to inflate with fluid upon depression of the plunger to within the chamber; and wherein said plunger is configured to be lockably positioned within said chamber whereby said head maintains an expanded and fluid filled configuration. In one mode of operation, the tip of said apparatus may be disposed within a nozzle of a sprinkler, the piston may be depressed to within the chamber and locked in a position, whereby the head expands within the nozzle and, thereby, blocks fluid from escaping the nozzle. Suitably, the plunger of the apparatus may be configured to melt whenever ambient temperatures surrounding the sprinkler reach a threshold level so that the sprinkler may reactivate in view of an unexpected fire in its proximity.

### BRIEF DESCRIPTION OF THE FIGURES

Other objectives of the disclosure will become apparent to those skilled in the art once the invention has been shown and described. The manner in which these objectives and other desirable characteristics can be obtained is explained in the following description and attached figures in which:

FIG. 1 is a perspective view of an apparatus 1 for deactivating sprinklers.

FIG. 2 is another perspective view of the apparatus 1 of FIG. 1.

FIG. 3 top view of the apparatus 1 of FIG. 1.

FIGS. 4A, 4B, and 4C are cross sections of the apparatus 1 of FIG. 1.

FIG. 5 is side view of the apparatus 1 of FIG. 1.

FIG. 6 is a rear view of the apparatus 1 of FIG. 1

FIGS. 7 and 8 are environmental views of the apparatus 1 of FIG. 1.

It is to be noted, however, that the appended figures illustrate only typical embodiments of this invention and are therefore not to be considered limiting of its scope, for the invention may admit to other equally effective embodiments that will be appreciated by those reasonably skilled in the relevant arts. Also, figures are not necessarily made to scale but are representative.

### DETAILED DESCRIPTION OF PREFERRED EMBODIMENTS

Disclosed are an apparatus and related methods for quickly deactivating or otherwise plugging a sprinkler, wherein the deactivated sprinkler may automatically reactivate in view of an unexpected fire. Generally, the disclosed apparatus comprises: a piston pump defined by a plunger that is movable within a fluid filled chamber; an expansible tip that is in fluid communication with said chamber; wherein said tip is configured to inflate with fluid upon depression of the plunger to within the chamber; and wherein said plunger is configured to be lockably positioned within said chamber whereby said head maintains an expanded and fluid filled configuration. In one mode of operation, the tip of said apparatus may be disposed within a nozzle of a sprinkler, the piston may be depressed to within the chamber and locked in a position, whereby the head expands within the nozzle and, thereby, blocks fluid from escaping the nozzle. Suitably, the plunger of the apparatus may be configured to melt whenever ambient temperatures surrounding the sprinkler reach a threshold level so that the sprinkler may reactivate in view of an unexpected fire in its proximity.

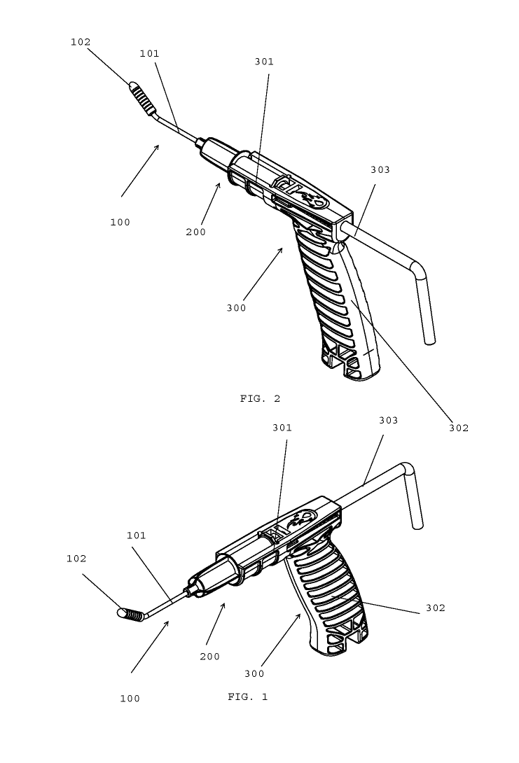

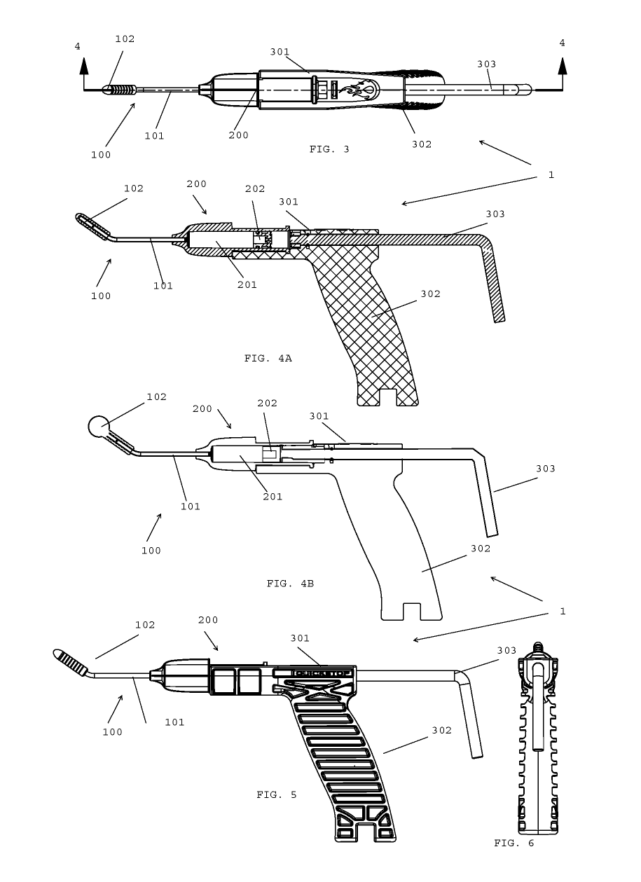

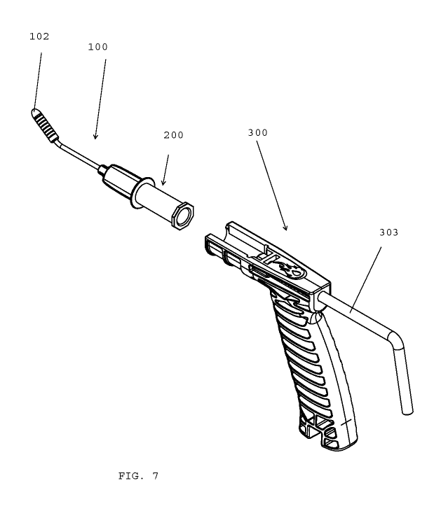

FIGS. 1 and 2 are respectively front and back perspective views an apparatus 1 for deactivating or otherwise plugging a sprinkler. FIGS. 3 through 7 are respectively top, cross-section (along line 4 of FIG. 2), side, rear, and environmental views of the apparatus 1 of FIG. 1. As shown in the figures (FIGS. 1 through 7), the apparatus 1 may be comprised of three components: (1) a tip 100; (2) a piston pump 200; and (3) a gun 300. The more specific details of the identified components are disclosed with reference to FIGS. 1 through 7.

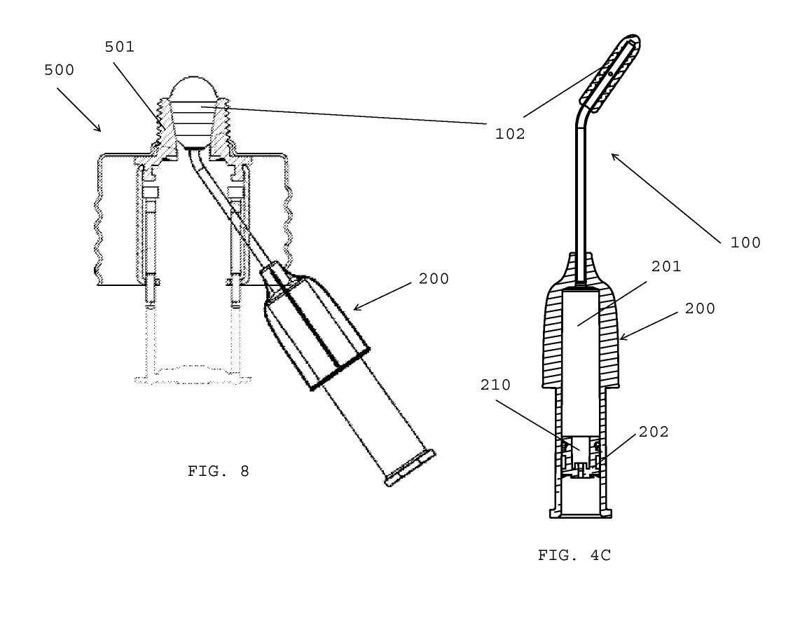

The tip 100 is shown in FIGS. 1 through 7 extending outwardly from the front of the piston pump 200. As seen in the FIG. 4A, the tip 100 may be generally defined by a hollow channel 101 that is coupled to a small inflatable bladder 102. As discussed in further detail below, pressurized fluid may be passed through the channel 101 into the bladder 102 so that the bladder 102 inflates as shown in FIG. 4B. As discussed below, the fluid may preferably be Suitably, said fluid may be gaseous (e.g., air) or liquid (e.g., water or oils).

The piston pump 200 is shown in FIGS. 1 through 7. As seen in FIG. 4, the piston pump 200 may be generally defined by a plunger 201 that is movable within a fluid filled chamber 202. Structurally, the chamber 202 may be a hollow, open-ended cylinder while the plunger 201 may generally be solid cylinder or other plug that is configured to slidingly move through the chamber's 202 hollow, via said open end, while maintaining a substantially fluid tight interface with the inner walls of the chamber 202. Practically, pressing the plunger 201 within the chamber 202 compresses the fluid disposed therein. Suitably, said fluid may be gaseous (e.g., air) or liquid (e.g., water or oils).

As shown in FIG. 7, the tip 100 and the piston pump 200 are preferably assembled as a single unit. Structurally, the tip 100 and piston pump 200 are preferably configured to be coupled together in a similar manner to the coupling of a tip and piston pump in a syringe. More specifically, the tip 100 and piston pump 200 are preferably coupled whereby the inflatable bladder 102 is in fluid communication the chamber 202 via the channel 101 (see FIG. 4B). Referring to FIGS. 4A and 4B, the tip 100 and piston pump 200 unit is operated by depressing the plunger 201 to within the chamber 202, which action correspondingly compresses the fluid within chamber 202 so that it moves through the channel and inflates the bladder 102 (compare FIGS. 4A and 4B). In a preferable embodiment, the channel 101 and chamber 202 are formed of molded plastics or metals, while the bladder 102 and plug 202 are formed of rubber or similar elastomeric materials.

The gun 300 is preferably illustrated by FIGS. 1 through 7. As seen in the figures, the gun 300 comprises a stock 301, a handle 302, and a trigger 303. The stock 301 is preferably positioned generally perpendicular to the handle 302 and suitably houses the trigger 303. The trigger 303, in one embodiment, is a cylindrical rod that is configured for axial movement lengthwise along the stock 301. The stock 301 may suitably be configured to releasably retain the tip 100 and piston pump 200 unit. Operably, the stock 300 is configured to receive the plunger 301 end of the piston pump 200 so that the plunger 301 may be manipulated via said movement of the trigger 303 (see FIGS. 4A and 4B). Suitably, the plunger 302 is configured for sliding movement in a forward direction toward the tip 100 while resisting sliding movements in a backward direction. Preferably the resistive force of the plunger in the backward direction is configured to withstand pressures within the chamber of at least one-hundred and twenty-five pounds per square inch. In one embodiment, said configuration is defined by a one way washer. Referring to FIG. 7, the tip 100 and piston pump 200 unit may be released from the stock 301 of the gun 300. Suitably, the gun 300 may be formed or assembled of molded plastics, molded or cut metals, or cut woods.

As shown in FIG. 8, the apparatus 1 may be used for deactivating or otherwise plugging a sprinkler 500 from inside its nozzle 501. In one mode of operation: (1) a tip 100 and piston pump 200 unit may be loaded into the stock 301 of the gun 300; (2) the uninflated bladder 102 of the tip 100 may be pressed into the nozzle of an activated sprinkler; (3) the trigger 302 may be shifted forward (see FIGS. 4A and 4B) to inflate the bladder 102 of the tip 100 until the inflated bladder 102 is sufficiently full of fluid to block the nozzle 501 of the sprinkler 500 (either by expanding until the bladder 102 interfaces with a wall or lip on the inside of the nozzle in a fluid type manner); and, (4) the tip 100 and piston pump 200 unit is detached from the stock 301 of the gun 300 whereby the sprinkler remains plugged. After installation, the gun 300 may be reloaded and used to shut down multiple sprinkler heads.

In one embodiment, the inflated tip 100 plus piston pump 200 unit may be designed to be left inside an active sprinkler as a means for extended sprinkler deactivation. Suitably, the piston pump 200 may be configured with: (A) a rubber plunger 302 which includes a fusible material that melts away when heated beyond a threshold temperature (see, e.g., U.S. Pat. No. 4,616,710 (issued Oct. 14, 1986)); and (B) retained within the chamber 301 of the piston pump 200 so that the bladder 102 remains inflated despite pressure being exerted thereon by fluids within the sprinkler. In one embodiment, the plunger 202 is a high temperature relief plug with a cavity 210 for wax, wherein the wax melts when heated beyond a threshold temperature so that the plug becomes no longer fluid tight (see FIG. 4C). In the present embodiment, said configuration of the piston pump allows an installed piston pump 200 plus inflated tip 100 to release from a fire sprinkler in view of an unexpected fire in the sprinkler's proximity.

It should be noted that other types of technologies employ piston pumps with inflatable tips or other structures that are similar to the disclosed apparatus. See e.g., U.S. Pat. No. 3,141,583 (issued Jul. 21, 1964); U.S. Pat. No. 3,162,230 (issued Dec. 22, 1964); U.S. Pat. No. 4,711,637 (issued Dec. 8, 1987); U.S. Pat. No. 6,110,143 (issued Aug. 29, 2000), U.S. Pat. No. 6,152,940 (issued Nov. 28, 2000); U.S. Pat. No. 7,347,865 (issued Mar. 25, 2008); and 2004/0127931 (published Jul. 1, 2004). However, these technologies fail to disclose tools for plugging or deactivating fire sprinklers, tools designed to be installed inside the nozzle of a sprinkler, tools for shutting down multiple heads in one location, and tools for stopping the flow of water from the inside of a pipe. By contrast, the disclosed apparatus possesses the above identified features, which allow the apparatus to be used on all sprinkler heads which are constructed and installed following the requirements of the National Fire Protection Agency (NFPA).

This specification and the appended figures illustrate only typical embodiments or principles disclosed in this application, and therefore, are not to be considered limiting of its scope, for the invention may admit to other equally effective embodiments that will be appreciated by those reasonably skilled in the relevant arts. For instance: the drawings show the tip 100 configured with a particular size, shape and angle, but it will be appreciated by those in the art that different positions and shapes may be employed for access and deactivating all types of sprinkler heads. Any invention disclosed by this specification is defined by the claims.

1. I claim an apparatus for deactivating sprinkler heads comprising:
an inflatable bladder in fluid communication with a piston pump.

2. The apparatus of claim 1 further comprising:
a gun having a stock and a trigger, wherein said stock is configured to releasably receive the piston pump, and wherein said trigger is configured to operate said piston pump so that said inflatable bladder is inflated.

3. I claim a method of deactivating a fire sprinkler comprising the steps of:
obtaining an apparatus comprising an inflatable bladder in fluid communication with a piston pump;
depositing said bladder inside the nozzle of an activated sprinkler; and,
inflating said bladder with said piston pump.

4. I claim an apparatus for rapidly stopping the flow of water from fire sprinklers comprising:
a tip featuring an inflatable bladder capable of receiving a fluid;
a piston pump for delivering said fluid there through and to said inflatable bladder;
wherein said tip and piston pump are operably activated by and separable from a gun.
